(19) United States
(12) Patent Application Publication
(10) Pub. No.: US 2011/0107338 A1
(43) Pub. Date: May 5, 2011

(54) Selecting isolation level for an operation based on manipulated objects

(75) Inventor: Tatu J. Ylonen, Espoo (FI)

(73) Assignee: TATU YLONEN OY LTD, Espoo (FI)

(21) Appl. No.: 12/611,159

(22) Filed: Nov. 3, 2009

(51) Int. Cl. G06F 9/46

(52) U.S. Cl. 718/102

(57) ABSTRACT

Concurrency control overhead in transactional memory and main memory databases is reduced by automatically selecting the appropriate isolation level for each operation based on the objects accessed by the operation.

### CROSS-REFERENCE TO RELATED APPLICATIONS

Not Applicable

### INCORPORATION-BY-REFERENCE OF MATERIAL SUBMITTED ON ATTACHED MEDIA

Not Applicable

### TECHNICAL FIELD

The present invention relates to concurrency control in transactional memory.

### BACKGROUND OF THE INVENTION

Database concurrency control is a mature field, where most of the currently dominant methods had been invented by the mid-1980's. A recent overview of various concurrency control methods can be found in Jan Lindstrom: Optimistic Concurrency Control Methods for Real-Time Database Systems, PhD Thesis, Report A-2003-1, Department of Computer Science, University of Helsinki, Finland. Other papers on concurrency control include, e.g., H. T. Kung and J. T. Robinson: On optimistic methods for concurrency control, ACM Transactions on Database Systems, 6(2):213-226, 1981 and P. Graham and K. Barker: Effective Optimistic Concurrency Control in Multiversion Object Bases, International Symposium on Object Oriented Methodologies and Systems (ISOOMS), LNCS 858, Springer, 1994.

Transactional memory refers to controlling access to data structures in a computer's memory using transactional mechanisms, somewhat similar to databases. Transactional memory is often seen as an alternative to locking in multiprocessor and multi-core systems, and some people think it is the future of multiprocessor computing. Papers describing the state of the art and various examples of transactional memory facilities include T. Harris et al: Optimizing Memory Transactions, PLDI'06, ACM, 2006; B. Saha et al: McRT-STM: A High Performance Software Transactional Memory System for a Multi-Core Runtime, PPoPP'06, ACM, 2006, pp. 187-197; Chi Cao Minh et al: An Effective Hybrid Transactional Memory System with Strong Isolation Guarantees, ISCA'07, ACM, 2007, pp. 69-80; and B. Carlstrom et al: Executing Java programs with transactional memory, Science of Computer Programming, 63:111-129, Elsevier, 2006.

The primary purpose of transactional concurrency control is to allow transactions to execute without concern to what other transactions are doing. Each transaction has the illusion of executing alone on the computer.

However, since achieving full isolation can be fairly expensive, many database systems allow the user to configure the desired isolation level on a per-transaction basis. Many databases support, e.g., SERIALIZABLE, REPEATABLE READ, READ COMMITTED, and READ UNCOMMITTED modes for isolation. More information on the various isolation levels can be found in A. Bernstein et al: Semantic Conditions for Correctness at Different Isolation Levels, ICDE'00 (International Conference on Data Engineering), IEEE, 2000, pp. 57-66 and A. Adya et al: Generalized Isolation Level Definitions, ICDE'00 (International Conference on Data Engineering), IEEE, 2000, pp. 67-78. The implementation of various isolation levels using locking is described in J. Gray et al: Granularity of Locks and Degrees of Consistency in a Shared Data Base, in Readings in Database Systems (M. Stonebraker, ed.), Morgan Kaufmann, 1994 (originally in Modeling in Data Base Management Systems, Elsevier, 1976).

The above referenced documents are hereby incorporated herein by reference.

Transactional memory implementations suffer from performance issues that have been difficult to overcome. Thus there exists a great need for solutions making transactional memory faster.

### BRIEF SUMMARY OF THE INVENTION

The present invention aims to improve performance of transactional memory by reducing the number of data items that must be logged while the transaction exists and verified when the transaction commits. Reducing the number of such items has a direct impact on transaction performance, particularly as such reductions can most advantageously be made for read operations, which have been observed to be much more frequent than write operations in practical transactional programs.

Eliminating items from the verification sets of transactions is closely related to reducing the isolation level of a transaction. However, the known method of controlling isolation level on a per-transaction basis is not appropriate for transactional memory, as the transactions executed using transactional memory tend to be much more complex (often comprising thousands or even millions of operations) than those executed in traditional databases. Thus, it is not practical to analyze the impact of reduced isolation of such complex transactions, if the isolation level is applied globally to all operations performed by the transaction.

However, the impact of reduced isolation can often be easily analyzed for some individual objects or groups of objects, or for particular sections of code. For example, in a web server application, it may be irrelevant to serialize a lookup for a web page from an index data structure; instead, it may suffice that the web page either is found or not, but it does not matter which the result is for a transaction executing just at the moment when it is being added. Thus, for those objects comprising the index, or for the section of code that implements the index lookup, it may suffice to have, e.g., READ COMMITTED semantics.

Transactions frequently call library functions that may be used for a number of data structures, and ideally various isolation levels may be mixed for different objects within the same higher-level operation. Therefore, it is often not enough to specify the desired isolation level for a section of code (e.g., a library function for tree traversal or sorting). Rather, the isolation level may need to be specified for the data operated on. The data operated on may be, e.g., objects or object fields (words).

The present invention is about selecting the isolation level for an operation performed within a transaction based on the data manipulated by the operation. Operations can be understood on many levels; at the lowest level, an operation is a read or write of a memory word; at a higher level, an operation may be a call to a complex function that, for example, performs an index lookup or handles an incoming e-mail. For the purposes of this invention, an operation should be understood as the lowest-level operation directly implemented by the transaction system. In many cases this is a read or a write, but in some cases it may also include cache lookups, specialized index lookups, commutative updates (e.g., adding a value to a field), etc.

A first aspect of the invention is a method of executing transactions in a computer, comprising:
selecting, by a transaction executing in the computer, the isolation level for an operation performed within the transaction based on the data manipulated by the transaction.

A second aspect of the invention is a computer comprising:
a transactional memory facility
coupled to the transactional memory facility, a means for selecting the isolation level for an operation performed within a transaction based on the data manipulated by the operation.

A third aspect of the invention is a computer program product stored on a computer-readable medium operable to cause a computer to select the isolation level for an operation based on the data manipulated by the operation, comprising:
a computer readable program code means for implementing transactional memory
a computer readable program code means for selecting the isolation level used by the transactional memory for an operation performed within a transaction based on the data manipulated by the operation.

### BRIEF DESCRIPTION OF THE SEVERAL VIEWS OF THE DRAWING(S)

FIG. 1 illustrates a computer according to an embodiment of the invention.

FIG. 2 illustrates performing a transaction in some embodiments of the invention that utilize opportunistic concurrency control.

### DETAILED DESCRIPTION OF THE INVENTION

It is to be understood that the aspects and embodiments of the invention described herein may be used in any combination with each other. Several of the aspects and embodiments may be combined together to form a further embodiment of the invention, and not all features, elements, or characteristics of an embodiment necessarily appear in other embodiments. A method, a computer, or a computer program product which is an aspect of the invention may comprise any number of the embodiments or elements of the invention described herein. Separate references to “an embodiment” or “one embodiment” refer to particular embodiments or classes of embodiments (possibly different embodiments in each case), not necessarily all possible embodiments of the invention.

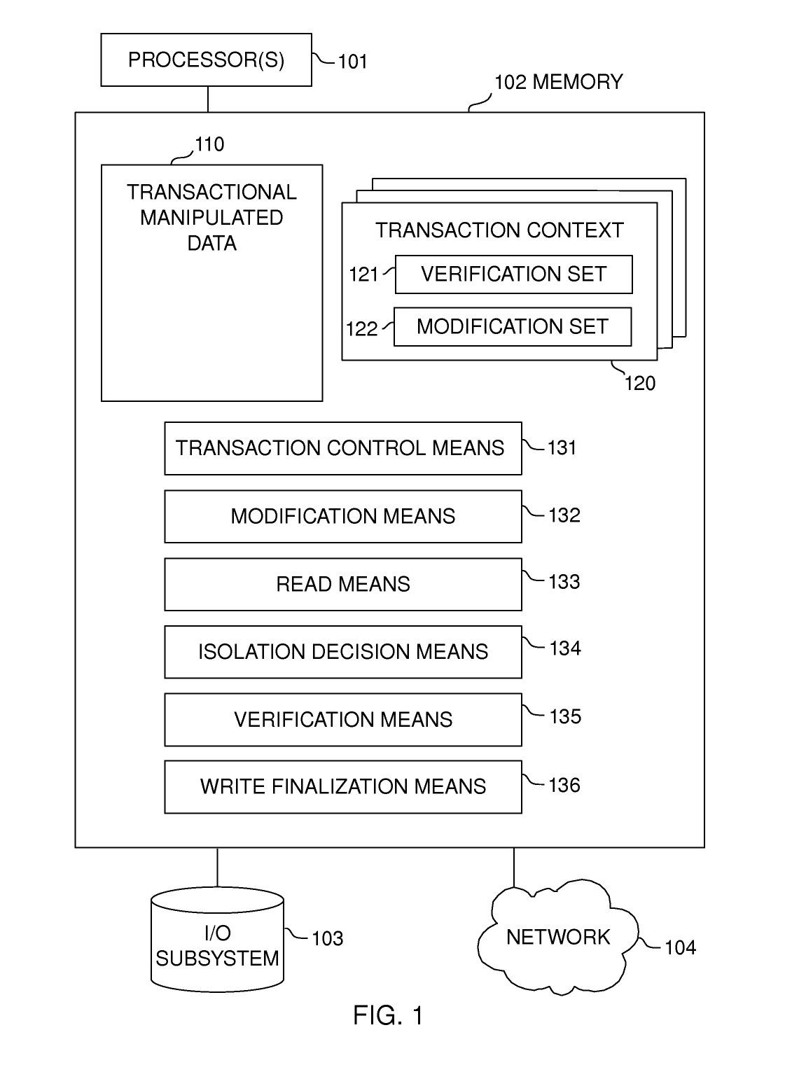

FIG. 1 illustrates a computer according to one possible embodiment of the invention. The computer comprises one or more processors (101), which may be, e.g., general purpose microprocessors, special-purpose knowledge processors, or ASICs for performing optimized operations, queries, analysis, or inference over semantic networks or other data representations. (102) illustrates the main memory of the computer (frequently a volatile semiconductor memory with present technology), (103) illustrates the I/O subsystem (typically comprising, e.g., a disk drive, keyboard, and display at the time of this writing), and (104) illustrates a network interface to the Internet, local area networks/interconnects, radio networks, or other communication facilities. The I/O subsystem and network interface may share the same interface to the rest of the computer or may each have one or more dedicated interfaces. Additional memory may be accessible through such interfaces.

(110) illustrates transactionally manipulated data in the computer's memory. It may be a database, knowledge base (such as a rule base, logical formula database, or a semantic network), or data structures in the program's memory in a program executed transactionally.

(120) illustrates one or more transaction contexts. Accesses and updates to the transactionally managed data are assumed to take place using transactions. If some data is accessed or modified without using transactions, then such data is not considered part of the transactionally managed data (even if such data is stored in fields of an object where some other fields are transactionally managed).

A transaction refers to a sequence of accesses or updates whose updates either all enter the database or none of them enter the database after the transaction commits. Whether other transactions can see partial updates (uncommitted data) before the transaction commits depends on the isolation level of the transaction(s).

Usually, but not always, a transaction corresponds to a thread of execution while the transaction is active. In some hardware embodiments a transaction may correspond to a dedicated execution context (a memory device or area, storing at least the state in the state machine of the transaction). When it is said that something is done by a transaction, it is meant that it is done under the control of the transaction and as part of the concurrency control and atomicity mechanisms offered by/for the transaction.

Each transaction is associated with a transaction context and usually executes on a single processor. In many embodiments (e.g., usually when using optimistic concurrency control) the transaction context comprises a verification set (121) comprising verification items and a modification set (122) comprising modification items. In some embodiments, each verification item identifies a node and a version number or an original value that the node must have when the transaction requests to commit (traditional optimistic concurrency control). In some other embodiments, the verification set also stores a copy of a read data item as it was when the transaction first accessed it (multiversion optimistic concurrency control). In some embodiments verification items correspond to read log entries, and modification items correspond to undo log entries.

In some embodiments, each modification item describes the new value of a data item modified by the transaction, all reads and writes perform a look-up in the modification set (sometimes called shadow copies), and the new values are written into the transactionally managed data when the transaction commits and verification has been successful. In some other embodiments, new values are written directly into the semantic network, and the modification items comprise information needed for undoing the transaction in case it needs to be aborted (e.g., if verification fails). In the latter case, some kind of locking is usually also employed to keep interaction of modification operations tractable.

(131) illustrates the means for controlling the execution of a transaction. In the preferred embodiment, the transaction control means is a state machine (preferably implemented in software, though hardware implementations are also possible) that triggers operations that access or modify the semantic network to be performed. It may select the next operation in such a way that later operations depend on the results returned by earlier operations. The last operation triggered by the transaction control means is typically a commit, which is intended to make any modifications by the transaction permanent. When using optimistic concurrency control, the commit typically involves a verification stage and a write stage (or unlocking stage), or an undo stage if the transaction fails. It would normally be structured such that it is restartable, so that if the commit fails, the transaction can be restarted. Such restart may or may not involve waiting some time (e.g., exponentially increasing random delay up to a limit) before starting over, and may be implemented, e.g., using a goto, a loop, a throw-catch mechanism, a non-local goto (or longjump), or by a state transition in a state machine.

The modification means (132) refers to circuitry or, e.g., program code that performs a modification operation on the transactionally managed data using the transaction context. There may also be some modifications that are called commutative; that is, modifications where the end result is not affected by their relative order. An example of a commutative modification is adding a constant to an integer field.

The read means (133) refers to circuitry or, e.g., program code that performs a read operation on the semantic network using the transaction context. The read operation may obtain the value being accessed from the transaction context or from the transactionally managed data, depending on the embodiment and whether the same data has been accessed or modified by the transaction earlier. The read means may also include query processing means, such as link enumerations, index lookups, transitive closure computations, activation spreadings, and inference operations in some embodiments.

The isolation decision means (134) refers to the mechanism used by the modification means and the read means for deciding when to create verification set entries (and in some embodiments, modification set entries) for operations performed on the transactionally managed data based on the data accessed (as opposed setting the isolation level to on a per transaction basis in the prior art). One of the things performed by the isolation decision means is selecting the isolation level for an operation performed within a transaction, based on the data manipulated in the operation. The isolation level is then typically implemented by the read means or the modification means. The isolation decision means may, e.g., compare object addresses or read data stored in a data object to decide how to isolate access to an object or a field of the object. The implementation and the decision may be integrated, such that the isolation means merges into the read and modification means. In such embodiments no explicit isolation level value may be derived; instead, the values from which the isolation level would be computed may directly drive the decision of whether to, e.g., create a verification set entry for some access. Even though the isolation level may be implicit in such cases, we still say that a level has been selected and implemented, as de facto the isolation level provided for the operation is still selected based on the data accessed by it. The isolation level may also depend, e.g., on the operation being performed.

The verification means (135) refers to the means used for verifying that the transaction can be serialized when it requests to commit. In some embodiments, it iterates over all verification items in the verification set, and checks for each item that the data or object referenced from the item still has the version number indicated in the item.

The write finalization means (136) refers to the means used for finalizing a transaction. In many embodiments it is used atomically with the verification means with respect to other transactions. The write finalization may comprise, depending on the embodiment, e.g., iterating through the modification set and performing all modifications indicated in the modification items to the semantic network, or unlocking data items (objects or their components, even individual words) that were locked by the transaction.

Together, (131) to (136) are used to implement optimistic concurrency control for transactions. (134), however, is used to relax the level of isolation provided based on the data accessed.

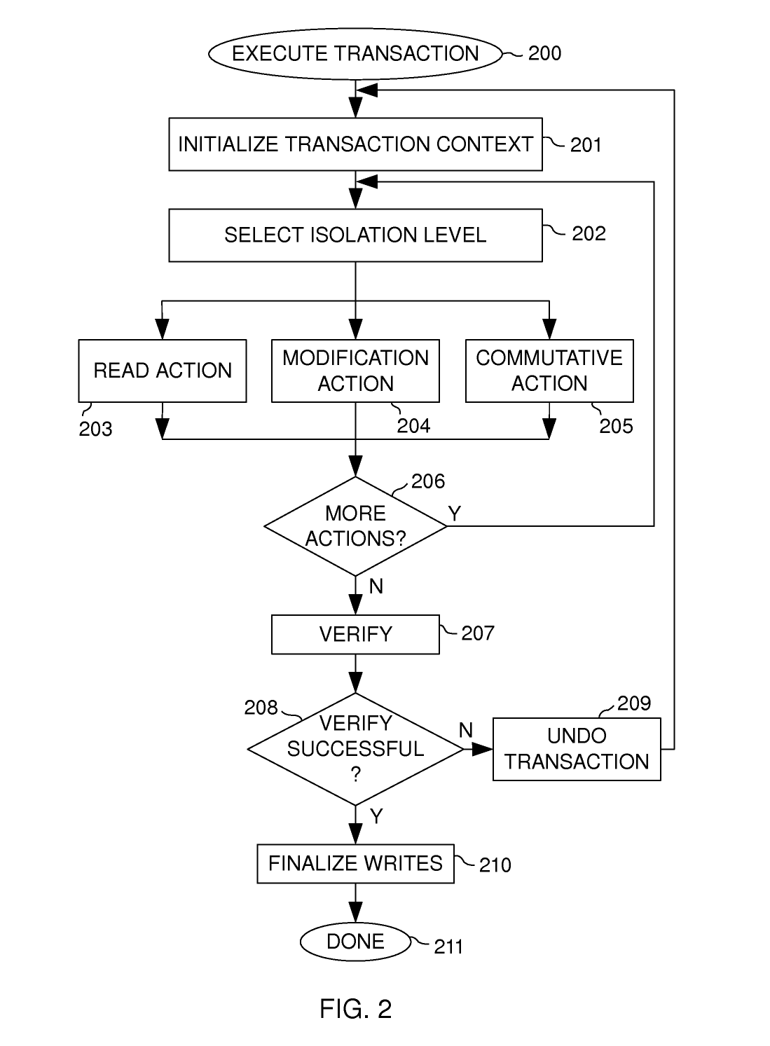

FIG. 2 illustrates executing a transaction using optimistic concurrency control and illustrates where the present invention integrates into execution of such transactions. (200) illustrates the start of a transaction. (201) initializes the transaction context (e.g., makes verification set and modifications sets empty). (202) selects the isolation level based (at least in part) on the data manipulated by the operation. (203) illustrates a read action, (204) a modification action, and (205) a commutative action.

(206) checks whether there is more work to be performed in the transaction. In the preferred embodiment, though, the various actions would typically be structured as a finite state machine or a computer program, and (206) may not be a real decision, but just illustrates whether the transaction has arrived at the final or “commit” state of the state machine.

The remaining steps illustrate committing a transaction. In a simple embodiment, a lock may be taken to perform operations (207) to (210) atomically with respect to other transactions. In some more sophisticated embodiments, such as those similar to Harris et al (2006), object or field level locking may be used to permit multiple transactions to be committing simultaneously while still providing isolation from other transactions.

In many embodiments (207) checks that the version numbers of data items mentioned in the verification set still match those indicated in verification items. In other embodiments it may use the read log to perform a similar check.

(208) checks whether the verification was successful. If the verification failed, the transaction must abort. If the transactionally managed data has not yet been modified (i.e., a delta data structure is used to hold uncommitted modifications), (209) may be a no-op; however, if written data is directly modified in the transactionally managed data, then (209) may use the undo log to undo the transaction and unlock the written data items or objects.

(210) finalizes writes made by the transaction, causing them to be visible to other transactions. Depending on the embodiment, this step may, e.g., write the changes indicated in the modification set to the transactionally managed data, or may, e.g., unlock previously written items in the transactionally managed data. (211) indicates the end of the transaction.

In practice some suitable mechanism would usually be used to limit the number of times a transaction is tried, such as a maximum time limit or a maximum number of attempts.

In the preferred embodiment the selection of the isolation level is very fast, as the present invention is primarily targeted for main memory data and transactional memory applications.

One way to select the isolation level quickly is to have some bit(s) or other value(s) in each object header indicate the desired isolation level. The isolation decision means then reads these bits, and based on their value selects an appropriate isolation level (e.g., one bit could be used to indicate whether verification set entries need to be created when the object is read). There could also be separate bits for each field of the object. These bits could reside either in the object itself or in a meta-object (e.g., class descriptor) referenced from the object. They could also be encoded in unused bits in the pointer to the object (especially in 64 bit systems). Some bit patterns could also cause the actual value to be fetched from some kind of extension record comprising more detailed information (e.g., if the object header does not have enough space for a bit for each field).

The isolation level may also depend on how an object is connected to other objects. For example, in a knowledge base comprising a semantic network or ontology, the desired isolation level might be configured for some classes in the ontology, and could be inherited to subclasses and instances. If the hierarchy is known at compile time or when an object is created, the object can be directly created with information about its isolation level stored in the relevant bits or other values in the object. In this case, the isolation level of the parent class is cached into the object by the bits or values. If the class hierarchy changes, the cache may need to be brought up to date. This may in some embodiments be done by a (possibly non-transactional) background process, or may be performed by traversing the subclass/instance tree/graph for the affected objects when making a change to the inheritance hierarchy in such a way that the isolation level for subordinate classes or instances is updated to the current level.

Another way to select the isolation level is to use the object's class(es). The object's class can usually be determined from the object in most run-time systems (e.g., by having a pointer to the object class in the object, or by having an index or some other class identifier stored in the object's header or in pointers to the object, or encoded implicitly by the address of the object). The isolation level can be configured on a per-class basis.

Yet another way to select the isolation level is to compare the address of the data against certain limit values. In some embodiments objects could be arranged in memory such that objects with a particular isolation level reside in a particular memory area, and the isolation level would be selected (at least in part) based on which memory area the object resides in. A variation of this is to store the objects in regions of a particular size, and fetch a region header for the region (e.g., by something like “reghdr=(RegHdr)(objaddr & ^{˜}(REGION_SIZE−1))”, if REGION_SIZE is a power of two and regions are stored at addresses that are multiples of REGION_SIZE).

It is well known how to implement an isolation level in lock-based systems, as many database systems support selecting the isolation level on a per-transaction basis (however, no known system allows selecting it for each operation based on the data manipulated by the operation).

For optimistic concurrency control schemes, the isolation level would typically be implemented by not adding verification items to the verification set for some operations. Some isolation levels may also be implemented by ignoring the updated-word bitmap of Harris et al (2006) for accesses that are allowed to read dirty data.

In some embodiments that use locking for modifications, there could be several levels of locking for each data item, possibly represented by more than one lock bit for a field or object.

Many variations of the above described embodiments will be available to one skilled in the art. In particular, some operations could be reordered, combined, or interleaved, or executed in parallel, and many of the data structures could be implemented differently. When one element, step, or object is specified, in many cases several elements, steps, or objects could equivalently occur. Steps in flowcharts could be implemented, e.g., as state machine states, logic circuits, or optics in hardware components, as instructions, subprograms, or processes executed by a processor, or a combination of these and other techniques. The invention is also not limited to opportunistic concurrency control, but can also be used with locking or combined opportunistic and lock-based concurrency control approaches.

A pointer should be interpreted to mean any reference to an object, such as a memory address, an index into an array, a key into a (possibly weak) hash table containing objects, a global unique identifier, or some other object identifier that can be used to retrieve and/or gain access to the referenced object. In some embodiments pointers may also refer to fields of a larger object.

A computer may be any general purpose computer, workstation, server, laptop, handheld device, smartphone, wearable computer, embedded computer, clustered computer, distributed computer, computerized control system, processor, or other apparatus with data processing capability.

Computer-readable media can include, e.g., computer-readable magnetic data storage media (e.g., floppies, disk drives, tapes, bubble memories), computer-readable optical data storage media (disks, tapes, holograms, crystals, strips), semiconductor memories (such as flash memory and various ROM technologies), media accessible through an I/O interface in a computer, media accessible through a network interface in a computer, networked file servers from which at least some of the content can be accessed by another computer, data buffered, cached, or in transit through a computer network, or any other media that can be read by a computer.

What is claimed is:

1. A method of executing transactions in a computer, comprising:
selecting, by a transaction executing in the computer, the isolation level for an operation performed within the transaction based on the data manipulated by the operation.

2. The method of claim 1, wherein the selection is made at run time, at least in part based on the address of the data manipulated by the operation.

3. The method of claim 1, wherein the selection is made at run time based at least in part on a value read from an object comprising data manipulated by the operation.

4. The method of claim 3, further comprising:
determining the isolation level required for an object based on its connectivity with other objects, and storing information indicating the isolation level in the object.

5. The method of claim 4, further comprising:
determining the isolation level required for each field of an object based on the object's connectivity with other objects, and storing information indicating the isolation level in the object separately for at least two fields.

6. The method of claim 4, further comprising:
updating, in at least one case, the information indicating the isolation level of the object when its connectivity with other objects changes.

7. The method of claim 1, further comprising:
in response to the per-operation isolation level indicating that full serializability is not required, reading at least one object without creating a verification item for it.

8. The method of claim 1, further comprising:
having more than one write lock level for the same object, different values indicating different isolation levels for the object; and
in response to a write to the object, setting the write lock indicator for the object in accordance with the isolation level.

9. A computer comprising:
a transactional memory facility
coupled to the transactional memory facility, a means for selecting the isolation level for an operation performed within a transaction based on one or more of the objects manipulated by the operation.

10. The computer of claim 9, wherein the means for selecting the isolation level selects the isolation level at run time based at least in part on a value read from an object comprising data manipulated by the operation.

11. The computer of claim 10, further comprising:
a means for determining the isolation level required for an object based on its connectivity with other objects and storing information about the isolation level in the object.

12. A computer program product stored on a computer-readable medium operable to cause a computer to select the isolation level for an operation based on the data manipulated by the operation, comprising:
a computer readable program code means for implementing transactional memory
a computer readable program code means for selecting the isolation level used by the transactional memory for an operation performed within a transaction based on one or more of the objects manipulated by the operation.

13. The computer program product of claim 12, wherein the computer readable program code means for selecting the isolation level is responsive to a value read from an object comprising data manipulated by the operation.

14. The computer program product of claim 13, further comprising:
a computer readable program code means for determining the isolation level required for an object based on its connectivity with other objects and storing information about the isolation level in the object.
